(19) United States
(12) Patent Application Publication
(10) Pub. No.: US 2023/0302702 A1
(43) Pub. Date: Sep. 28, 2023

(54) INJECTION MOLDING MANAGEMENT SYSTEM

(71) Applicant: SEIKO EPSON CORPORATION, Tokyo (JP)

(72) Inventors: Hiroki MINOWA, Matsumoto (JP); Kosuke ATSUTA, Shiojiri (JP)

(21) Appl. No.: 18/187,731

(22) Filed: Mar. 22, 2023

(30) Foreign Application Priority Data
Mar. 24, 2022 (JP) 2022-047915

(51) Int. Cl. B29C 45/76

(52) U.S. Cl. CPC B29C 45/768; B29C 2945/7629; B29C 2945/76936

(57) ABSTRACT

An injection molding management system includes: an identification information acquisition unit acquiring molded product identification information for identifying a molded product; a defect category acquisition unit acquiring, when the molded product is equivalent to a defective product, first defect category information representing a category of a defect of the molded product and second defect category information representing a category of a defect that is different from the first defect category information of the molded product; and a storage unit storing the first defect category information and the second defect category information in association with the molded product identification information of the molded product.

The present application is based on, and claims priority from JP Application Serial Number 2022-047915, filed Mar. 24, 2022, the disclosure of which is hereby incorporated by reference herein in its entirety.

### BACKGROUND

### 1. Technical Field

The present disclosure relates to an injection molding management system.

### 2. Related Art

With respect to an injection molding management system, JP-A-2014-69382 discloses a technique in which, as a user selects a defect category such as burn mark, short shot or sink mark via a selection button, defect category information and a shot number are stored corresponding to each other and the number of defects is shown in a graph for each position in a metal mold, based on the defect category information and defect occurrence site information.

The graph described in JP-A-2014-69382 enables the user to visually check the number of defect cases occurring at each position in the metal mold. According to the related art, this type of technique needs a technique that can comprehensively determine a factor that causes a defect occurring in injection molding and thus take preventive measures accordingly.

### SUMMARY

According to an aspect of the present disclosure, an injection molding management system for a molded product is provided. The injection molding management system includes: an identification information acquisition unit acquiring molded product identification information for identifying a molded product; a defect category acquisition unit acquiring, when the molded product is equivalent to a defective product, first defect category information representing a category of a defect of the molded product and second defect category information representing a category of a defect that is different from the first defect category information of the molded product; and a storage unit storing the first defect category information and the second defect category information in association with the molded product identification information of the molded product.

### BRIEF DESCRIPTION OF THE DRAWINGS

FIG. 1 is an explanatory view showing a schematic configuration of an injection molding management system.

FIG. 2 shows an example of defect information database.

FIG. 3 is a flowchart of aggregation processing executed by a processing unit.

FIG. 4 shows an example of a result of aggregation of number-of-defect-cases information.

FIG. 5 shows an example of showing the result of aggregation of the number of defect cases.

FIG. 6 shows another example of showing the result of aggregation of the number of defect cases.

FIG. 7 shows another example of showing the result of aggregation of the number of defect cases.

FIG. 8 shows another example of showing the result of aggregation of the number of defect cases.

FIG. 9 shows another example of showing the result of aggregation of the number of defect cases.

FIG. 10 shows an input screen for specifying representative defect category information.

FIG. 11 shows an example of an input screen for defect occurrence site information and defect category information.

### DESCRIPTION OF EXEMPLARY EMBODIMENTS

### A. First Embodiment

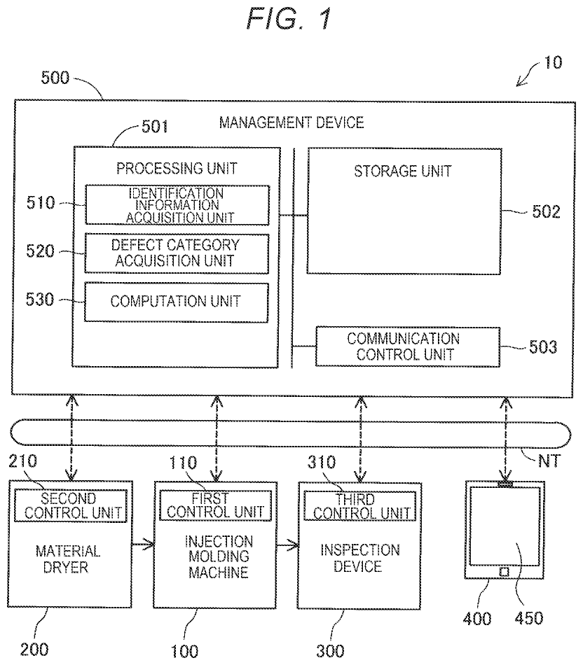

FIG. 1 is an explanatory view showing a schematic configuration of an injection molding management system 10 according to a first embodiment. The injection molding management system 10 according to this embodiment has an injection molding machine 100, a material dryer 200, an inspection device 300, a terminal device 400, and a management device 500. The management device 500 is coupled in such a way as to be able to communicate with the injection molding machine 100, the material dryer 200, the inspection device 300, and the terminal device 400. In this embodiment, the management device 500 is configured to be able to communicate with these devices via a network NT. The network NT may be, for example, a LAN, a WAN, or the internet. The injection molding machine 100, the material dryer 200, and the inspection device 300 may be arranged, for example, in the same casing or casings coupled to each other and combined together in a unified manner and may thus be configured as an injection molding unit.

The injection molding machine 100 is a device performing injection molding. The injection molding machine 100 has a first control unit 110, and an injection device and a mold clamping device, neither of which is illustrated. In the mold clamping device, a shaping mold having a cavity is installed. The shaping mold may be made of a metal, a ceramic, or a resin. The shaping mold made of a metal is referred to as a metal mold. The first control unit 110 is formed of a computer having one or a plurality of processors, a storage device, and an input-output interface for inputting and outputting a signal from and to outside. The first control unit 110 may be formed of a plurality of computers. A second control unit 210 of the material dryer 200 and a third control unit 310 of the inspection device 300 are configured similarly to the first control unit 110.

The first control unit 110 controls each part of the injection molding machine 100 to perform injection molding and thus mold a molded product. More specifically, the first control unit 110 controls the mold clamping device to clamp the shaping mold, controls the injection device to plasticize a material and inject the material into the shaping mold, and thus molds a molded product having a shape corresponding to the shape of the cavity provided in the shaping mold. The molded product thus molded is transported to the inspection device 300 by a transportation device such as an extraction robot, not illustrated.

The first control unit 110 transmits physical quantity information representing a physical quantity about injection molding to the management device 500. The physical quantity information includes measured values measured by various sensors provided in the injection molding machine 100 and various command values about injection molding. The command values are values set in the injection molding machine 100, such as injection and filling times, injection pressure, and set temperature. The measured values are values acquired by the sensors measuring these actual values.

The material dryer 200 is a device drying a material to be supplied to the injection molding machine 100. The material dryer 200 has the second control unit 210, and a heater and a drying hopper, neither of which is illustrated. The material dryer 200 removes moisture from air with a moisture absorbent, heats the dry air by the heater, feeds the heated air into the drying hopper, and thus dries a material stored in the drying hopper. The dried material is fed under pressure to the injection molding machine 100 by a pressure pump, not illustrated. The second control unit 210 controls the drying temperature of the heater and the air flow rate of the dry air fed into the drying hopper.

The inspection device 300 is a device performing an image inspection. The inspection device 300 is formed of the third control unit 310 and a camera. The third control unit 310 controls the camera to pick up an image of a molded product, analyzes the picked-up image of the molded product, and thus performs an external inspection of the molded product. In this external inspection, a defect of the molded product such as burr, sink mark, burn mark, or haze is inspected. The inspection device 300 in this embodiment picks up an image of the molded product from one direction and can inspect a plurality of types of defects from the one picked-up image. The third control unit 310 transmits, for each molded product, inspection information representing the result of the inspection of the molded product to the management device 500. The inspection information includes defect category information representing the type of the defect of the molded product.

The terminal device 400 is formed of a computer having a CPU, a storage device, and a display unit 450. As the terminal device 400, for example a tablet terminal, a laptop personal computer, a smartphone, or a handheld terminal can be applied. In this embodiment, the display unit 450 is provided with a touch panel function. On the display unit 450, various screens outputted from the management device 500 are displayed. In another embodiment, the display unit 450 may be provided in the management device 500.

The management device 500 is formed of a computer having a processing unit 501, a storage unit 502, and a communication control unit 503. The processing unit 501 has one or a plurality of processors and a main storage device. The storage unit 502 is formed of an auxiliary storage device such as a hard disk drive. The communication control unit 503 has a communication circuit for controlling communication with other devices such as the injection molding machine 100, the material dryer 200, the inspection device 300, and the terminal device 400.

The processing unit 501 has an identification information acquisition unit 510, a defect category acquisition unit 520, and a computation unit 530. The identification information acquisition unit 510, the defect category acquisition unit 520, and the computation unit 530 are implemented by the processing unit 501 executing a program stored in the storage unit 502. These units may also be implemented by a circuit.

The identification information acquisition unit 510 acquires molded product identification information for identifying a molded product. The molded product identification information is formed of, for example, a combination of a lot number and a shot number. In this embodiment, the identification information acquisition unit 510 acquires the molded product identification information of a molded product that has been inspected, from the inspection device 300. The identification information acquisition unit 510 may acquire the molded product identification information from the injection molding machine 100.

The defect category acquisition unit 520 acquires defect category information representing the category of a defect of a molded product when the molded product is equivalent to a defective product. The defect category information represents the category of a defect such as burr, sink mark, burn mark, or haze. In this embodiment, the defect category acquisition unit 520 acquires inspection information including the defect category information from the inspection device 300. As described above, the inspection device 300 in this embodiment can inspect a plurality of types of defects from one image. Therefore, the defect category acquisition unit 520 can acquire a plurality of types of defect category information from the inspection device 300 with respect to one molded product. The plurality of types of defect category information include a first defect category information representing the category of the defect of the molded product and second defect category information representing the category of a defect that is different from the first defect category information.

The computation unit 530 aggregates, for each unit of aggregation, the defect categories acquired by the defect category acquisition unit 520. For example, when the defect category acquisition unit 520 acquires the first defect category information and the second defect category information, the computation unit 530 calculates first number-of-defect-cases information formed by aggregating the first defect category information for each unit of aggregation, and second number-of-defect-cases information formed by aggregating the second defect category information for each unit of aggregation. The unit of aggregation is a unit representing a group in which molded products are manufactured, such as year, month, week, day, hour, lot, box, tray, number of metal mold cavities, or type of molded product. The unit of aggregation may be predetermined or may be arbitrarily designated by the user. The number-of-defect-cases information calculated by the computation unit 530 is outputted to the terminal device 400 and displayed on the display unit 450.

In the storage unit 502, defect information database DB is stored. In the defect information database DB, the molded product identification information acquired by the identification information acquisition unit 510 and the defect category information acquired by the defect category acquisition unit 520 are recorded in association with each other. When the defect category acquisition unit 520 acquires a plurality of pieces of defect category information, for example, the first defect category information and the second defect category information, the first defect category information and the second defect category information are recorded in association with the molded product identification information in the defect information database DB.

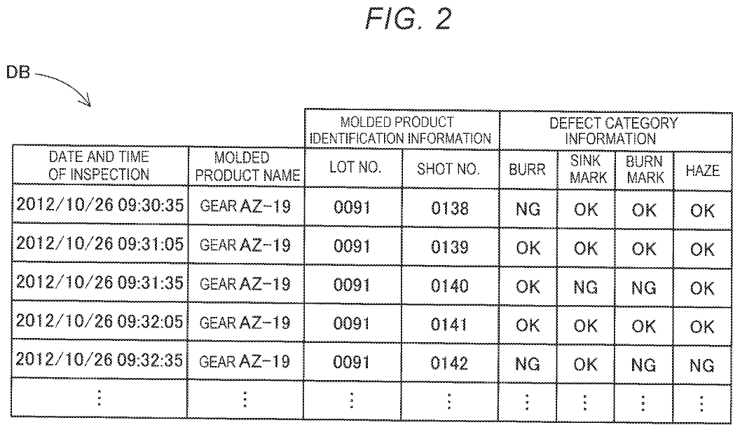

FIG. 2 shows an example of the defect information database DB. In the defect information database DB in this embodiment, the date and time of inspection when an inspection is performed by the inspection device 300, the name of a molded product that is inspected, the lot number, the shot number, and the result of the inspection about each of burr, sink mark, burn mark, and haze are recorded in association with each other. A combination of the lot number and the shot number is equivalent to the molded product identification information. The result of the inspection about each of burr, sink mark, burn mark, and haze is equivalent to the defect category information.

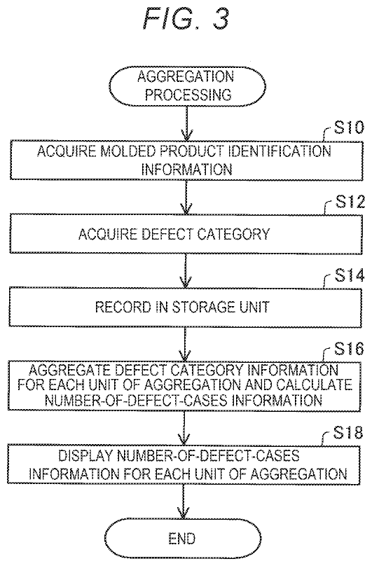

FIG. 3 is a flowchart of aggregation processing executed by the processing unit 501. This aggregation processing is the processing for displaying the number-of-defect-cases information on the display unit 450.

In step S10, the identification information acquisition unit 510 of the processing unit 501 acquires the molded product identification information from the inspection device 300.

In step S12, the defect category acquisition unit 520 of the processing unit 501 acquires the defect category information from the inspection device 300.

In step S14, the processing unit 501 records the molded product identification information acquired in step S10 and the defect category information acquired in step S12 in association with each other in the defect information database DB in the storage unit 502.

In step S16, the computation unit 530 of the processing unit 501 aggregates the defect category information for each unit of aggregation and thus calculates the number-of-defect-cases information.

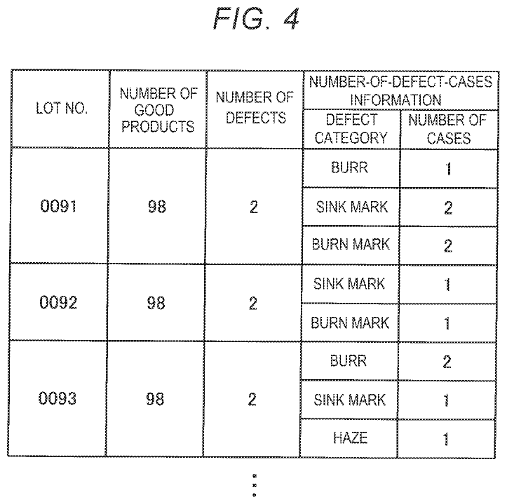

FIG. 4 shows an example of the result of the aggregation of the number-of-defect-cases information. In FIG. 4, the result of aggregating the defect category information for each lot as the unit of aggregation is shown. In the example shown in FIG. 4, in relation to a lot number, the number of good molded products, the number of defects in molded products, and the number-of-defect-cases information, in the lot, correspond. In the number-of-defect-cases information, the number of cases in each defect category in each lot is aggregated and recorded.

In step S18 in FIG. 3, the processing unit 501 transmits the number-of-defect-cases information aggregated for each unit of aggregation in step S16 to the terminal device 400. The terminal device 400 displays the received information on the display unit 450. In this embodiment, the management device 500 causes the display unit 450 to display a graph showing the result of the aggregation shown in FIG. 4. The display unit 450 may also display the table of the result of the aggregation shown in FIG. 4 along with the graph.

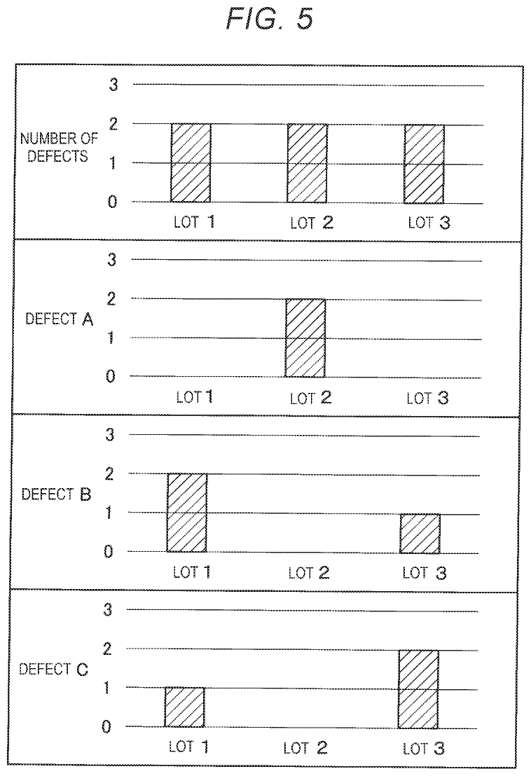

FIG. 5 shows an example where the result of the aggregation of the number of defect cases is shown in a graph. In FIG. 5, a bar graph titled “number of defects” shows the total number of defects in each lot. FIG. 5 shows that two defect cases occur in each lot of lots 1 to 3. A bar graph titled “defect A” shows that two defect cases in a defect category of “defect A” occur in lot 2. A bar graph titled “defect B” shows that two defect cases in a defect category of “defect B” occur in lot 1 and that one defect case in this defect category occurs in lot 3. A bar graph titled “defect C” shows that one defect case in a defect category of “defect C” occurs in lot 1 and that two defect cases in this defect category occur in lot 3. In this embodiment, one, or two or more defect categories are recorded in association with one molded product in the defect information database DB. That is, different defect categories are associated with one molded product. Therefore, the total number of cases of defect A, defect B, and defect C in each lot does not coincide with the number of defects.

From the graphs shown in FIG. 5, the following can be understood.
(1) For the same number of defects, a plurality of types of different defects exist.
(2) In many cases, defect B and defect C occur simultaneously. Therefore, when one measure reduces the number of defects for both defect B and defect C, it can be understood that the causes of these defects are the same. Also, this is useful for such verification.
(3) When defects have different causes, it may appear from the graph of the number of defects alone that the measure taken does not improve the situation and is therefore ineffective, whereas it is seen from the graphs shown in FIG. 5 that the number for defect C is increased in lot 1 and lot 3 but the number for defect B is reduced and therefore it can be understood that the measure taken is effective for defect B.
(4) Defect A does not occur simultaneously with any other defects and therefore may have a different cause. Thus, it can be understood in advance that, due to different modes and causes of defects, a plurality of measures need to be taken in order improve all the numbers of defects. Consequently, a plurality of measures can be planned in advance and the measures can be taken in a planned manner.

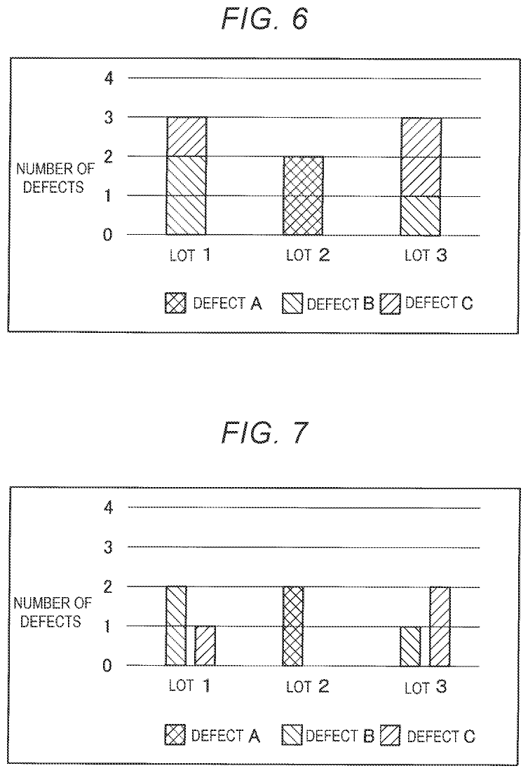

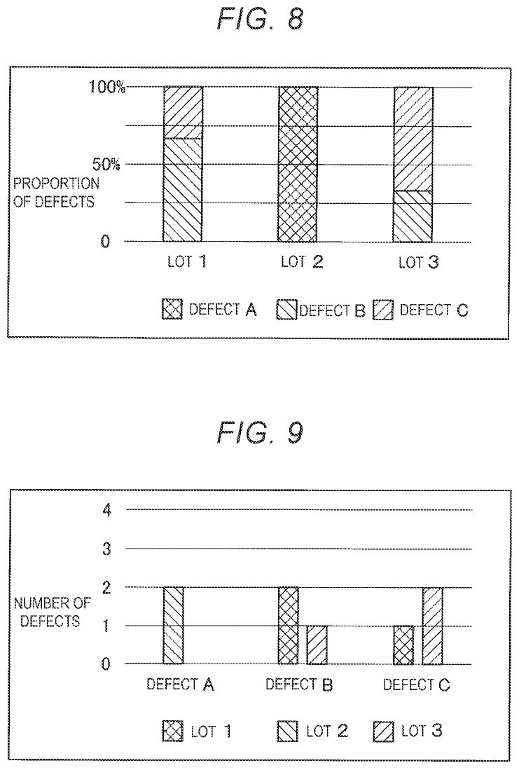

FIGS. 6 to 9 show other examples of showing the result of the aggregation of the number of defect cases. FIG. 6 shows an example where the number of cases for each of defects A to C in each lot is shown in a stacked bar chart. FIG. 7 shows an example where the number of cases for each of defects A to C in each lot is shown in parallel bar charts. FIG. 8 shows an example where the proportion of each of defects A to C in each lot is shown in a 100% stacked bar chart. FIG. 9 shows that the number of cases in each lot is shown in parallel bar charts for each defect category. Using these graphs along with the graphs shown in FIG. 5 or instead of the graphs shown in FIG. 5, useful information can be provided to the user.

In the injection molding management system 10 according to this embodiment described above, a plurality of types of defect category information are stored in association with molded product identification information. Therefore, the user can comprehensively determine a plurality of defects present in one molded product and can take measures accordingly. Thus, defects at the plant as a whole can be reduced. Also, in this embodiment, a plurality of types of defect category information are each aggregated for each unit of aggregation such as lot. Therefore, the user can easily recognize a plurality of types of defects occurring in the unit of aggregation.

An advantage of associating a plurality of types of defect categories with one molded product, instead of associating one defect category with one molded product, will now be described. For example, it is assumed that 15 cases of defect A (for example, warp), five cases of defect B (for example, insufficient strength), one case of defect C (for example, burn mark), one case of defect D (for example, air bubbles), and one case of defect E (for example, sink mark) are detected. In this case, the user may consider measures to cope with the two defects of warp and insufficient strength, which are highly cost-effective, based on the result of the detection, and may resume the production from the next lot under molding conditions changed in such a way as to “reduce the injection pressure, reduce the injection time, and raise the cylinder temperature”. However, one molded product often includes a plurality of types of defects instead of only one. For example, in the case where a defective product having the insufficient strength and the warp also includes the defect of air bubble, when the molding conditions are changed in such a way as to “reduce the injection pressure, reduce the injection time, and raise the cylinder temperature”, air bubbles tend to occur and the number of defective products may rather increase due to the occurrence of air bubbles at a site where strength is needed, thus increasing the number of defect cases of the insufficient strength or increasing the number of defect cases of the air bubbles, or the like. Therefore, simply associating one defect category with one molded product has a problem in that it is difficult for the user to take appropriate measures. In contrast, in this embodiment, a plurality of types of defect categories can be associated with one molded product. Therefore, the number of cases of a defect (for example, air bubbles) hidden behind another representative defect is greater than in the result of the aggregation in the case where one defect category is associated with one molded product. Thus, the user can change the molding conditions in such a way as to “raise the metal mold temperature and raise the injection speed”, taking not only the warp and the insufficient strength but also the air bubbles into account, and thus can resume the production from the next lot. Consequently, the number of defects at the plant as a whole can be reduced.

Also, in this embodiment, while a plurality of types of defect categories are associated with one molded product, the same type of defect category is not associated a plurality of times with one molded product. Associating the same type of defect category a plurality of times with one molded product refers to, for example, associating “burr” twice as a defect category to a molded product when a burr is generated at each of the lateral surface and the bottom surface of the molded product. If the same type of defect category is associated a plurality of times with one molded product in this way, when the number of defects is aggregated and displayed for each predetermined unit of aggregation, whether the defects are defects of the same defect category occurring in one molded product or defects occurring in different molded products cannot be determined. Therefore, when five cases of the defect category of haze are stored for one molded product and one case of the defect category of burr is stored for each of five molded products, there is a risk that the user viewing the aggregated numbers of cases may handle measures to cope with the defects of haze and burr at the same priority level, while actually the defective product with a haze is an unexpected defect and the measure to cope with the defect of burr should be prioritized. Therefore, the user may erroneously recognize the defect category that frequently occurs in the production process. However, in this embodiment, the same type of defect category is not associated a plurality of times with one molded product. Therefore, such erroneous recognition can be prevented.

In the first embodiment, the management device 500 acquires the molded product identification information and the defect category information from the inspection device 300. However, the management device 500 may acquire the molded product identification information and the defect category information via an input from the user. The user may input these pieces of information to the management device 500, for example, using an input device such as a keyboard, or may input data aggregated by another computer or the like to the management device 500.

### B. Second Embodiment

In the first embodiment, the defect category acquisition unit 520 of the processing unit 501 acquires a plurality of types of defect category information with respect to one piece of molded product identification information and stores these pieces of information in the storage unit 502. In a second embodiment, the defect category acquisition unit 520 specifies representative defect category information from among two or more types of defect category information including the first defect category information and the second defect category information. The configuration of the injection molding management system 10 in the second embodiment is the same as in the first embodiment.

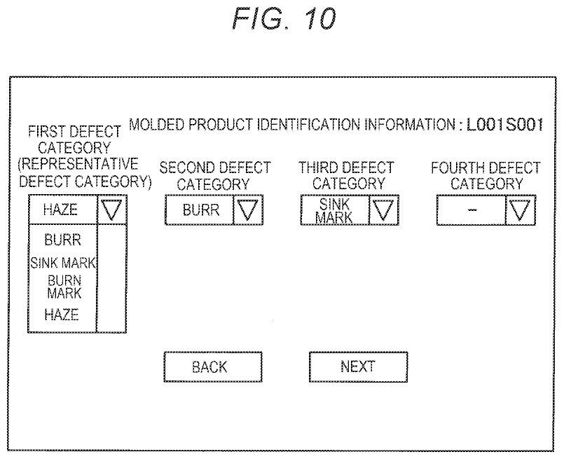

FIG. 10 shows an input screen for specifying representative defect category information. In the second embodiment, it is assumed that the defect category acquisition unit 520 acquires the molded product identification information and the defect category information from the user via the input screen displayed on the display unit 450. In the input screen shown in FIG. 10, a drop-down list for designating a defect category is arranged for each of a first defect category, a second defect category, a third defect category, and a fourth defect category. The user designates one or a plurality of types of defect categories corresponding to the molded product identification information, using these drop-down lists. The defect category acquisition unit 520 acquires the defect category information designated from each drop-down list and specifies the defect category information acquired from the drop-down list corresponding to the first defect category, from among these pieces of defect category information, as representative defect category information. The processing unit 501 then records the representative defect category information distinguishably from the other defect category information in the defect information database DB in the storage unit 502. In this embodiment, the computation unit 530 calculates representative number-of-defect-cases information formed by aggregating the number of cases of the representative defect category information for each unit of aggregation and causes the display unit 450 to display the representative number-of-defect-cases information. When the number of cases of the representative defect category information is aggregated for each unit of aggregation, the value thereof coincides with the number of defects for each unit of aggregation. While in FIG. 10, the representative defect category information is specified using the drop-down list, for example, a method that can specify the representative defect category information from among a plurality of pieces of defect category information, such as arranging a check box or the like for each defect category and causing the user to specify the representative defect category information, may be employed.

In the second embodiment described above, a plurality of types of defect category information can be stored in association with one piece of molded product identification information, but at the time of aggregation, the number of cases of the representative defect category information may be aggregated. Therefore, the load on the computation unit 530 calculating the number of defects and the defect rate can be reduced. In the second embodiment, too, the number of cases of not only the representative defect category information but also a plurality of types of defect category information, as shown in FIGS. 4 and 5, may be aggregated and displayed. Also, the user may be able to select the display of the result of the aggregation of a plurality of types of defect category information or the display of the result of the aggregation of the representative defect category information.

In the above second embodiment, the defect category acquisition unit 520 specifies the representative defect category information from among the defect category information acquired from the user via the input screen displayed on the display unit 450. However, the defect category acquisition unit 520 may specify the representative defect category information from among the defect category information acquired from the inspection device 300. In this case, for example, the defect category acquisition unit 520 accepts a designation of representative defect category information from the user in advance and specifies the designated representative defect category information from among the defect category information acquired from the inspection device 300. The representative defect category information may be decided in advance in the management device 500 instead of being selected by the user.

### C. Third Embodiment

In the second embodiment, the defect category acquisition unit 520 acquires a plurality of types of defect category information from the user via the input screen displayed on the display unit 450. In a third embodiment, the defect category acquisition unit 520 accepts not only a plurality of types of defect category information but also a selection of a defect occurrence site indicating the site of occurrence of each defect, via the input screen displayed on the display unit 450. In the storage unit 502, defect occurrence site information representing each defect occurrence site is stored in association with a plurality of pieces of defect category information including the first defect category information and the second defect category information.

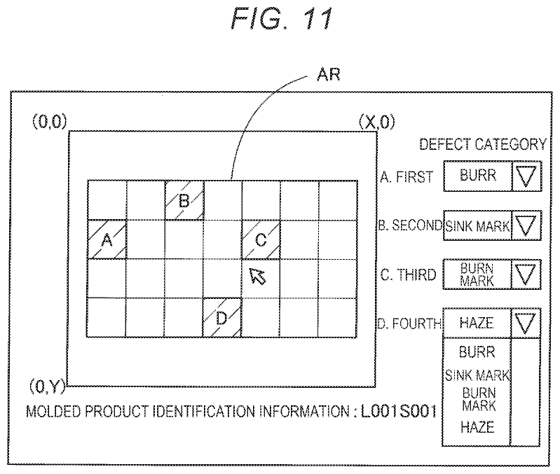

FIG. 11 shows an example of the input screen for the defect occurrence site information and the defect category information. In the input screen, an area AR for accepting an input of the defect occurrence site information is arranged. The shape and size of the area AR correspond to the outer shape of the molded product. The area AR is divided into small areas each having a predetermined size. The user selects a small area corresponding to the position where a defect has occurred, using the touch panel function of the display unit 450, and thus can input the defect occurrence site information. For example, the user selects a small area corresponding to the defect occurrence position, subsequently selects the corresponding defect category from a drop-down list for designating a defect category, arranged on the right in the input screen, and thus can designate the defect category with respect to the selected area. The user repeats the selection of a small area and the selection of a defect category and thus can make different defect categories correspond to a plurality of small areas. The defect category acquisition unit 520 acquires an input operation to the display unit 450, from the terminal device 400, and thus records a plurality of types of defect category information and the defect occurrence site information corresponding to each defect category in association with each other, for each molded product identification information, in the defect information database DB in the storage unit 502.

In the third embodiment described above, the defect occurrence site and the defect category information can be stored for each molded product in the storage unit 502. Therefore, the number of cases of the defect category information for each defect occurrence site can be aggregated and displayed on the display unit 450. Thus, the user can grasp what defect has occurred at which position in the molded product.

### D. Other Embodiments

In the above embodiments, in the storage unit 502, the first defect category information and the second defect category information are recorded in association with the molded product identification information. That is, a plurality of types of different defect category information are associated with one molded product. Meanwhile, in the storage unit 502, the first defect category information and the second defect category information may be associated with production unit identification information for identifying a predetermined unit of production such as lot, box, or tray. Thus, a plurality of types of defect categories can be linked to each unit of production and therefore the number of cases of the defect category information can be aggregated and displayed for each unit of production. That is, in the storage unit 502, the database in the form shown in FIG. 4 may be stored instead of the form of the defect information database DB shown in FIG. 2. In this case, for example, the defect category acquisition unit 520 acquires the defect category information and the number-of-defect-cases information for each unit of production from the user or the inspection device.

### E. Other Aspects

The present disclosure is not limited to the foregoing embodiments and can be implemented with various configurations without departing from the spirit and scope of the present disclosure. For example, a technical feature in the embodiments corresponding to a technical feature in the aspects described below can be replaced or combined where appropriate in order to solve a part or all of the foregoing problems or in order to achieve a part or all of the foregoing effects. The technical feature can be deleted where appropriate, unless described as essential in the present specification.
(1) According to an aspect of the present disclosure, an injection molding management system is provided. The injection molding management system includes: an identification information acquisition unit acquiring molded product identification information for identifying a molded product; a defect category acquisition unit acquiring, when the molded product is equivalent to a defective product, first defect category information representing a category of a defect of the molded product and second defect category information representing a category of a defect that is different from the first defect category information of the molded product; and a storage unit storing the first defect category information and the second defect category information in association with the molded product identification information of the molded product.

In the injection molding management system according to this aspect, a plurality of types of defect category information are stored in association with the molded product identification information. Thus, the user can comprehensively determine a plurality of types of defects present in one molded product and thus can take measures accordingly. Therefore, defects at the plant as a whole can be reduced.
(2) The injection molding management system according to the above aspect may further include: a computation unit calculating first number-of-defect-cases information formed by aggregating the first defect category information for each unit of aggregation, and second number-of-defect-cases information formed by aggregating the second defect category information for the each unit of aggregation; and a display unit displaying the first number-of-defect-cases information and the second number-of-defect-cases information for the each unit of aggregation. According to this aspect, a plurality of types of defect category information can be each aggregated and displayed for each unit of aggregation. Therefore, the user can easily recognize a plurality of types of defects occurring in the unit of aggregation.
(3) In the injection molding management system according to the above aspect, the defect category acquisition unit may specify representative defect category information from among two or more types of defect category information including the first defect category information and the second defect category information. The injection molding management system may include a computation unit calculating representative number-of-defect-cases information formed by aggregating the representative defect category information for each unit of aggregation. According to this aspect, the representative defect category information is aggregated and therefore the load on the computation unit can be reduced.
(4) In the injection molding management system according to the above aspect, the storage unit may store defect occurrence site information representing a defect occurrence site in association with the first defect category information and the second defect category information. According to this aspect, a defect corresponding to a position in the molded product can be grasped.
(5) According to another aspect of the present disclosure, an injection molding management system is provided. The injection molding management system includes: a defect category acquisition unit acquiring, when a molded product is equivalent to a defective product, first defect category information representing a category of a defect of the molded product and second defect category information representing a category of a defect that is different from the first defect category information of the molded product; and a storage unit storing the first defect category information and the second defect category information in association with production unit identification information for identifying a unit of production of the molded product.

What is claimed is:

1. An injection molding management system comprising:
an identification information acquisition unit acquiring molded product identification information for identifying a molded product;
a defect category acquisition unit acquiring, when the molded product is equivalent to a defective product, first defect category information representing a category of a defect of the molded product and second defect category information representing a category of a defect that is different from the first defect category information of the molded product; and
a storage unit storing the first defect category information and the second defect category information in association with the molded product identification information of the molded product.

2. The injection molding management system according to claim 1, further comprising:
a computation unit calculating first number-of-defect-cases information formed by aggregating the first defect category information for each unit of aggregation, and second number-of-defect-cases information formed by aggregating the second defect category information for the each unit of aggregation; and
a display unit displaying the first number-of-defect-cases information and the second number-of-defect-cases information for the each unit of aggregation.

3. The injection molding management system according to claim 1, wherein
the defect category acquisition unit specifies representative defect category information from among two or more types of defect category information including the first defect category information and the second defect category information,
the injection molding management system further comprises a computation unit calculating representative number-of-defect-cases information formed by aggregating the representative defect category information for each unit of aggregation.

4. The injection molding management system according to claim 1, wherein
the storage unit stores defect occurrence site information representing a defect occurrence site in association with the first defect category information and the second defect category information.
